(19) United States
(12) Patent Application Publication
(10) Pub. No.: US 2015/0253780 A1
(43) Pub. Date: Sep. 10, 2015

(54) SYNCHRONIZATION CONTROL APPARATUS

(71) Applicant: FANUC Corporation, Minamitsuru-gun (JP)

(72) Inventor: Manabu SAITOU, Minamitsuru-gun (JP)

(21) Appl. No.: 14/640,516

(22) Filed: Mar. 6, 2015

(30) Foreign Application Priority Data
Mar. 10, 2014 (JP) 2014-046866

(51) Int. Cl. G05D 3/12

(52) U.S. Cl. CPC G05D 3/121

(57) ABSTRACT

A synchronization control apparatus includes a movement amount calculation unit and a movement unit. The movement amount calculation unit calculates a movement amount required for a slave axis to move in accordance with the position of a master axis in such a manner that the slave axis moves to a designated position when the master axis arrives at a designated position, and that the speed ratio of the slave axis to the master axis is as designated. The movement unit moves the slave axis to the position that is forward of the designated position by the movement amount calculated by the movement amount calculation unit, and then moves the slave axis to an end point in accordance with the position of the master axis.

### BACKGROUND OF THE INVENTION

1. Field of the Invention

The present invention relates to a synchronization control apparatus that provides drive control with a plurality of axes synchronized.

2. Description of the Related Art

FIG. 1 is a diagram illustrating a situation where a master axis and a slave axis perform a synchronous operation at a fixed speed ratio during a designated interval. FIG. 2 is a diagram illustrating a situation where the master axis and the slave axis are moved while the speed ratio of the slave axis to the master axis is gradually changed.

When the master axis 1 and the slave axis 2 perform a synchronous operation at a fixed speed ratio during a designated interval (see <1> in FIG. 1), the speed of the slave axis 2 is determined by multiplying the speed of the master axis 1 by the speed ratio immediately after the start of the synchronous operation. If, in this instance, the slave axis 2 is stopped at a synchronous operation start position, a shock is generated by a sudden speed change.

A synchronization control apparatus disclosed in Japanese Patent Application Laid-Open No. 2006-164009 moves a master axis and a slave axis while gradually changing the speed ratio of the slave axis to the master axis. When this operation is performed during an interval preceding a synchronization start position of the slave axis 2, the speed of the slave axis 2 can be gradually changed (see <2> in FIG. 2). However, the resulting change is not always gradual depending on the amount of movement of the slave axis 2. This necessitates a calculation of the movement amount beforehand in order to achieve desired acceleration. It should also be noted that a change in the speed of the master axis 1 causes a change in the acceleration of the slave axis 2.

If an operation for simultaneously achieving the position and speed ratio between the master axis 1 and the slave axis 2 (hereinafter referred to as a synchronization preparation operation) is performed at the beginning of a synchronous operation without properly setting a slave axis movement amount for the synchronization preparation operation, proper acceleration is not achieved. Further, when the speed of the master axis 1 changes, the acceleration of the slave axis 2 also changes and cannot be maintained constant.

### SUMMARY OF THE INVENTION

In view of the above-described problems in the prior art techniques, an object of the present invention is accordingly to provide a synchronization control apparatus that performs a synchronization preparation operation by calculating the start point of an acceleration interval during which a slave axis can gradually accelerate toward a synchronization start position, moving a master axis and the slave axis, and gradually accelerating the slave axis in accordance with the movement of the master axis.

The synchronization control apparatus according to the present invention initiates a synchronous operation immediately after a slave axis moves to a designated position while a master axis moves to a designated position. The synchronization control apparatus includes a designation unit, a movement amount calculation unit, and a movement unit. The designation unit designates a position of the master axis, a position of the slave axis, and a speed ratio that prevails when the master axis and the slave axis finish their designated movement. The movement amount calculation unit calculates a movement amount required for the slave axis to move in accordance with the position of the master axis in such a manner that the slave axis moves to the designated position when the master axis arrives at the designated position, and that the speed ratio of the slave axis to the master axis is as designated by the designation unit. The movement unit moves the slave axis to the position that is forward of the designated position by the movement amount calculated by the movement amount calculation unit, and then moves the slave axis to an end point in accordance with the position of the master axis.

The synchronization control apparatus according to the present invention initiates a synchronous operation immediately after a slave axis moves a designated distance while a master axis moves to a designated position. The synchronization control apparatus includes a designation unit, a movement amount calculation unit, and a movement unit. The designation unit designates a position of the master axis, a movement amount of the slave axis, and a speed ratio that prevails when the master axis and the slave axis finish their designated movement. The movement amount calculation unit calculates a movement amount required for the slave axis to move in accordance with the position of the master axis in such a manner that the slave axis moves the designated distance when the master axis arrives at the designated position, and that the speed ratio of the slave axis to the master axis is as designated by the designation unit. The movement unit moves the slave axis by an amount that is calculated by subtracting the movement amount calculated by the movement amount calculation unit from the designated movement amount, and then moves the slave axis to an end point in accordance with the position of the master axis.

The synchronization control apparatus according to the present invention initiates a synchronous operation immediately after a slave axis moves to a designated position while a master axis moves a designated distance. The synchronization control apparatus includes a designation unit, a movement amount calculation unit, and a movement unit. The designation unit designates a movement amount of the master axis, a position of the slave axis, and a speed ratio that prevails when the master axis and the slave axis finish their designated movement. The movement amount calculation unit calculates a movement amount required for the slave axis to move in accordance with the position of the master axis in such a manner that the slave axis moves to the designated position when the master axis finishes moving the designated distance, and that the speed ratio of the slave axis to the master axis is as designated by the designation unit. The movement unit moves the slave axis to the position that is forward of the designated position by the movement amount calculated by the movement amount calculation unit, and then moves the slave axis to an end point in accordance with the position of the master axis.

The synchronization control apparatus according to the present invention initiates a synchronous operation immediately after a slave axis moves a designated distance while a master axis moves a designated distance. The synchronization control apparatus includes a designation unit, a movement amount calculation unit, and a movement unit. The designation unit designates a movement amount of the master axis, a movement amount of the slave axis, and a speed ratio that prevails when the master axis and the slave axis finish their designated movement. The movement amount calculation unit calculates a movement amount required for the slave axis to move in accordance with the position of the master axis in such a manner that the slave axis moves by the designated movement amount when the master axis finishes moving the designated distance, and that the speed ratio of the slave axis to the master axis is as designated by the designation unit. The movement unit moves the slave axis by an amount that is calculated by subtracting the movement amount calculated by the movement amount calculation unit from the designated movement amount, and then moves the slave axis to an end point in accordance with the position of the master axis.

The synchronization control apparatus may include a unit that designates an acceleration of the slave axis. The movement amount calculation unit may calculate a movement amount in such a manner that the acceleration prevailing during movement agrees with the designated acceleration.

The movement unit may move the slave axis at a speed that is calculated by adding an axis speed of the slave axis for movement to an acceleration start position to an axis speed for accelerating the slave axis in accordance with the master axis.

When configured as described above, the present invention can automatically maintain a constant acceleration operation of the slave axis during the synchronization preparation operation without having to change a program even if a change is applied to the position of the slave axis and the speed of the master axis that prevail at the beginning of the synchronization preparation operation. Therefore, when, for instance, the acceleration is designated, it is possible to stabilize the influence on machining that is performed after the start of a synchronous operation.

### BRIEF DESCRIPTION OF THE DRAWINGS

The above and other objects and features of the present invention will be apparent from the following description of embodiments that is given with reference to the appended drawings, in which:

FIG. 1 is a diagram illustrating a situation where a master axis and a slave axis perform a synchronous operation at a fixed speed ratio during a designated interval;

FIG. 2 is a diagram illustrating a situation where the master axis and the slave axis are moved while the speed ratio of the slave axis to the master axis is gradually changed;

FIG. 3 is a diagram illustrating a system according to a first embodiment of the present invention;

FIG. 4 shows an example of a program that instructs how the slave axis should operate;

FIG. 5 shows changes in the speeds of prior art master axis and slave axis;

FIG. 6 is a diagram illustrating changes in the position of the master axis and in the speed of the slave axis that occur when the slave axis accelerates at a fixed acceleration;

FIG. 7 shows that acceleration is achieved in accordance with the movement of the master axis when the amount of movement of the slave axis is divided into X₁ and X₂;

FIG. 8 is a diagram illustrating the system according to a second embodiment of the present invention;

FIG. 9 is a diagram illustrating the system according to a third embodiment of the present invention;

FIG. 10 illustrates a fifth embodiment of the present invention;

FIG. 11 illustrates a sixth embodiment of the present invention;

FIG. 12 is a diagram illustrating a numerical control apparatus that controls industrial machines and other machines;

FIG. 13 is a flowchart illustrating a process according to the first embodiment; and

FIG. 14 is a flowchart illustrating the process according to the sixth embodiment.

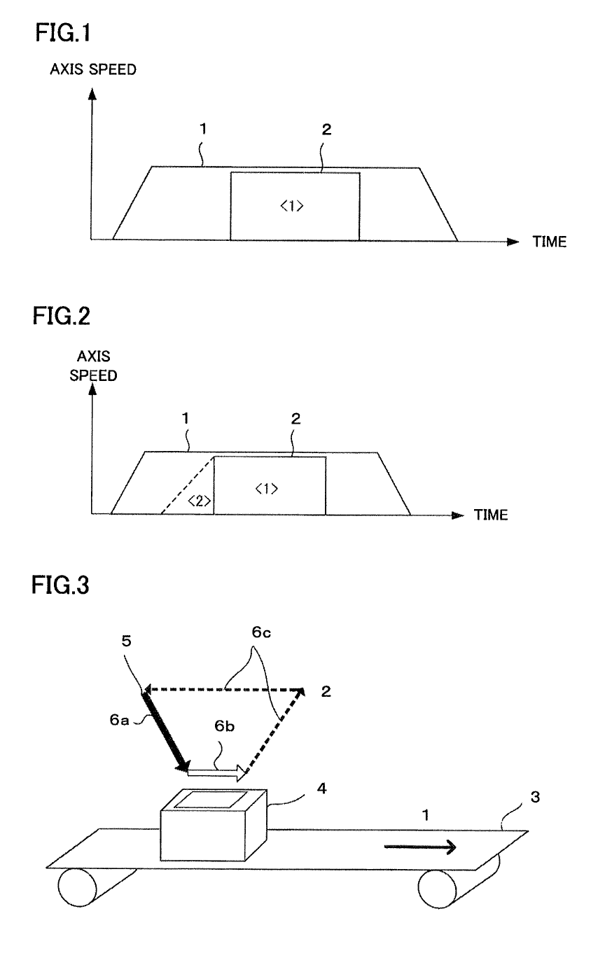

### DETAILED DESCRIPTION OF THE PREFERRED EMBODIMENTS

### First Embodiment

A first embodiment of the present invention is included in claim 1.

FIG. 3 is a diagram illustrating a system according to the first embodiment. The system formed of a conveyor 3 and a printing device (not shown) will now be described as an example. The system performs a printing process while a workpiece 4 transported by the conveyor 3 driven by a master axis 1 and a tool (printing device) driven by a slave axis 2 are synchronized at the same speed during an interval defined by a program.

However, if the slave axis 2 is suddenly synchronized with the master axis 1 in a state where the slave axis 2 is stopped at a start point of a synchronization interval, the speed of the slave axis 2 drastically changes from zero to generate a mechanical shock.

As such being the case, the system shown in FIG. 3 performs three different operations to move the slave axis 2 toward the conveyor. A state where the tool (printing device) is positioned forward in the direction of travel, that is positioned on the left side of FIG. 3, corresponds to a start point 5 of a cycle. The aforementioned three operations are a synchronization preparation operation 6a, a synchronous operation 6b, and a return operation 6c. When the tool (printing device) is positioned at the start point 5 of the cycle, the synchronization preparation operation 6a, the synchronous operation 6b, and the return operation 6c are sequentially performed in this order.

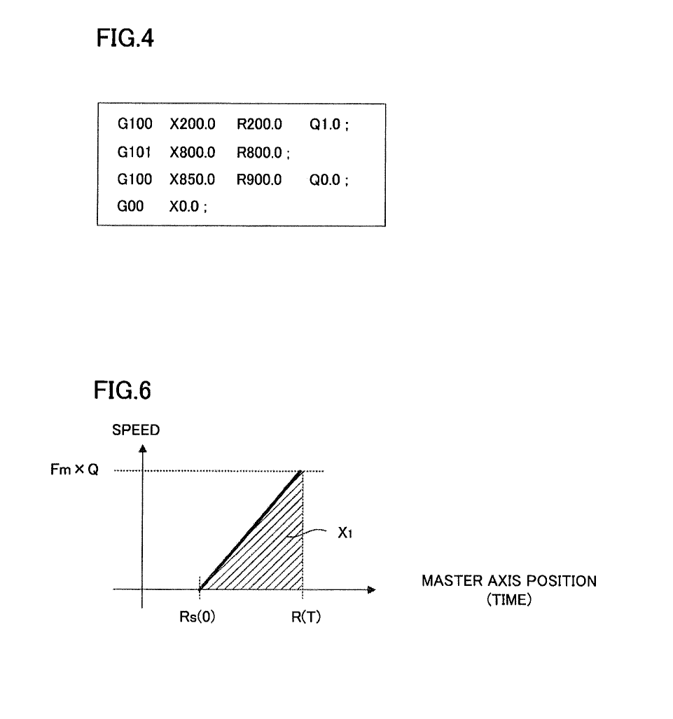

If the slave axis 2 synchronizes with the master axis 1 during an interval between the 200 mm position and 800 mm position of the slave axis 2, the operation of the slave axis 2 in this machining cycle is specified as indicated by a program shown in FIG. 4.

G100 is a command designating the synchronization preparation operation. X designates a slave axis position that prevails at the end of command execution. R designates a master axis position that prevails at the end of command execution. Q designates the speed ratio of the slave axis 2 to the master axis 1 that prevails at the end of command execution. G101 is a command designating the synchronous operation. The meanings of X and R for G101 are the same as for G100. G00 is an axis movement command that moves the slave axis 2 rapidly to an end point position and then stops it. When combined with the preceding command (“G100 with Q0.0”), this axis movement command performs the return operation.

The synchronization preparation operation according to the present embodiment is an operation performed to move the slave axis in such a manner that the slave axis just arrives at an end point position of the synchronization preparation operation when the master axis moves to an end point position of the synchronization preparation operation. The synchronization preparation operation according to the present embodiment is based on a command that provides acceleration/deceleration for attaining the designated speed ratio at the same time.

The synchronization control apparatus disclosed in Japanese Patent Application Laid-Open No. 2006-164009 performs a synchronization preparation operation by moving the slave axis in accordance with the movement of the master axis and changing the speed ratio in such a manner as to provide a designated movement amount of the slave axis. When the synchronous operation is performed subsequently to the synchronization preparation operation as described above, the speed changes of the master and slave axes become continuous between two different operations. This prevents the generation of a significant shock.

However, the synchronization control apparatus disclosed in Japanese Patent Application Laid-Open No. 2006-164009 generates a mechanical shock during an acceleration operation if the movement amount of the slave axis is improper during the synchronization preparation operation. This will now be explained with reference to FIG. 5. If, for instance, the movement amount of the slave axis is small, drastic acceleration occurs because acceleration is achieved within a very short period of time. If, on the contrary, the movement amount is large, drastic acceleration occurs as well because the speed of the slave axis is rapidly adjusted for the speed of the master axis. Further, if the master axis is operated with its speed changed, the acceleration of the slave axis also changes by an amount equivalent to the change in the speed of the master axis. Therefore, the setting for the movement amount of the slave axis needs to be changed in order to achieve constant acceleration. In the synchronization control apparatus disclosed in Japanese Patent Application Laid-Open No. 2006-164009, a speed change pattern of the slave axis during the synchronization preparation operation is determined by the designated movement amount of the slave axis and by the designated speed of the master axis.

On the other hand, the present embodiment calculates a movement amount required for the acceleration of the slave axis from the speed of the master axis and the speed change pattern of the acceleration operation, and moves, immediately after the issuance of a command, the slave axis to a position required for performing the operation. During the synchronization preparation operation, the slave axis is moved in a sequence described below.

(1) The following values designated by the program (see FIG. 4) and the position and speed of the master axis are acquired. Here, the position of the master axis is represented by Xₘ and the speed of the master axis is represented by Fₘ.
End point position of the slave axis X=200.0
End point position of the master axis R=200.0
Speed ratio between the master and slave at an end point of synchronization preparation operation Q=1.0

As an operating condition for the slave axis, acceleration/deceleration time is represented by T. The acceleration/deceleration time T is preset as a parameter in the synchronization control apparatus.

(2) A movement amount X₁ during an acceleration interval of the slave axis and a master axis position Rₛ for the start of acceleration are calculated in accordance with the master axis speed Fₘ, the end point speed ratio Q, and the acceleration/deceleration time T.

First of all, let us suppose a slave axis speed f (Xₘ) during an acceleration operation that agrees with the acceleration/deceleration time T of the slave axis. The function f is determined by the position Xₘ of the master axis and satisfies the relationship given in Equation 1.

f(R)=Fₘ×Q (1)

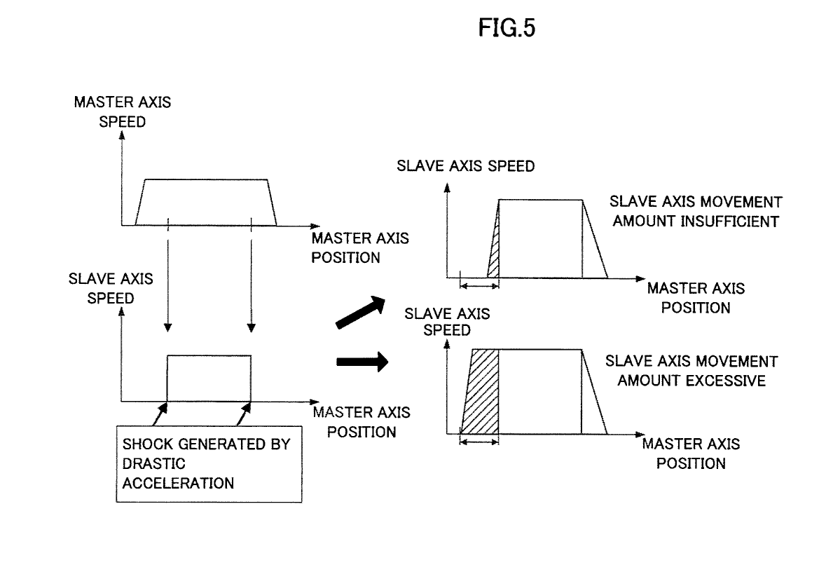

In other words, when the master axis arrives at the end point (Xₘ=R), the slave axis speed is Q times Fₘ. Therefore, when the slave axis accelerates at a fixed acceleration, the slave axis speed changes as shown in FIG. 6. When the master axis moves at a constant speed, its time and movement amount are in proportion to each other. Therefore, it can be considered that the horizontal axis of FIG. 6 represents time.

As the slave axis completely accelerates in time T, the amount of movement X₁ during the acceleration interval is calculated from Equation 2.

X₁=(Fₘ×Q×T)/2 (2)

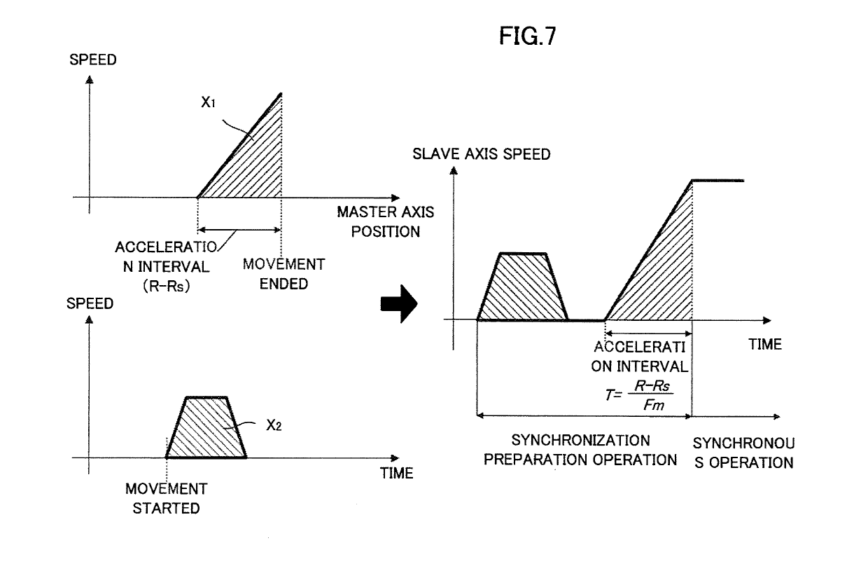

FIG. 7 shows that the slave axis is accelerated in accordance with the movement of the master axis by dividing the movement amount of the slave axis into two movement amounts, namely, X₁ and X₂. The speed is determined from the movement amount X₁ depends on the master axis position. However, the movement amount of the master axis moving at a constant speed is proportional to time. Therefore, it can be considered that the movement amount is determined by time. The speed determined from the movement amount X₁ is then combined with the speed determined from the movement amount X₂ to depict the slave axis speed attained during the synchronization preparation operation.

Let us assume that the amount of movement of the slave axis to the end point position X of the synchronization preparation operation is expressed by X₁ and X₂. The movement amount X₂ is to be added to the movement amount X₁ in order to supply the deficiency. The value X₂ may differ from the value X₁ in sign.

Further, when the slave axis moves by the movement amount X₁ toward the end point position of the synchronization preparation operation, the position Rₛ of the master axis, which is a condition for the start of that movement, is calculated from Equation 3. The position Rₛ of the master axis is a master axis position at which the slave axis starts moving for the synchronization preparation operation in accordance with the master axis.

Rₛ=R−(Fₘ×T) (3)

(3) For the movement amount X₂, which is calculated as described in (2) above, the slave axis is moved and stopped before the master axis arrives at the position Rₛ.

First of all, when the synchronization preparation operation starts, the slave axis begins to move by the movement amount X₂. This movement may be made without regard to the master axis. Therefore, for instance, the slave axis accelerates and decelerates to move rapidly in accordance, with a time constant T.

(4) Subsequently, a check is performed to determine whether the master axis has passed its position Rₛ at which the slave axis begins to accelerate. If the master axis has not passed its position Rₛ, the speed is set to be zero. If the master axis has passed its position Rₛ, the slave axis is moved in accordance with the position of the master axis. In this instance, a command designating a speed is issued by calculating f (Xₘ).

When the slave axis finishes moving by the movement amount X₁ for the acceleration interval, the synchronization preparation operation terminates, and then the next operation, that is, the synchronous operation, starts.

When the movement amount of the slave axis is divided into two movement amounts, namely, X₁ and X₂, as described above, the movement amount X₁ for the interval during which acceleration is performed in accordance with the movement of the master axis can be maintained within a proper range. Thus, even if the speed of the master axis is changed, the slave axis operation during the acceleration interval can be adapted to meet desired conditions by varying the movement amount X₁ without changing the program.

In the present embodiment, the slave axis starts the synchronization preparation operation when it is stopped. However, if a movement command is issued immediately before the synchronization preparation operation, the slave axis may operate without changing its speed that prevails at an end point of a preceding operation. Further, the present embodiment has been described on the assumption that two axes connected to the synchronization control apparatus, namely, the master axis and the slave axis, are subjected to synchronization control. Alternatively, however, an additional axis may also be controlled as a slave axis. Furthermore, when the master axis is connected to an external control apparatus, the position and speed of the master axis may be fed back from its position/speed detector so that synchronization control is exercised to move the slave axis according to that position.

### Second Embodiment

A second embodiment of the present invention is included in claim 2.

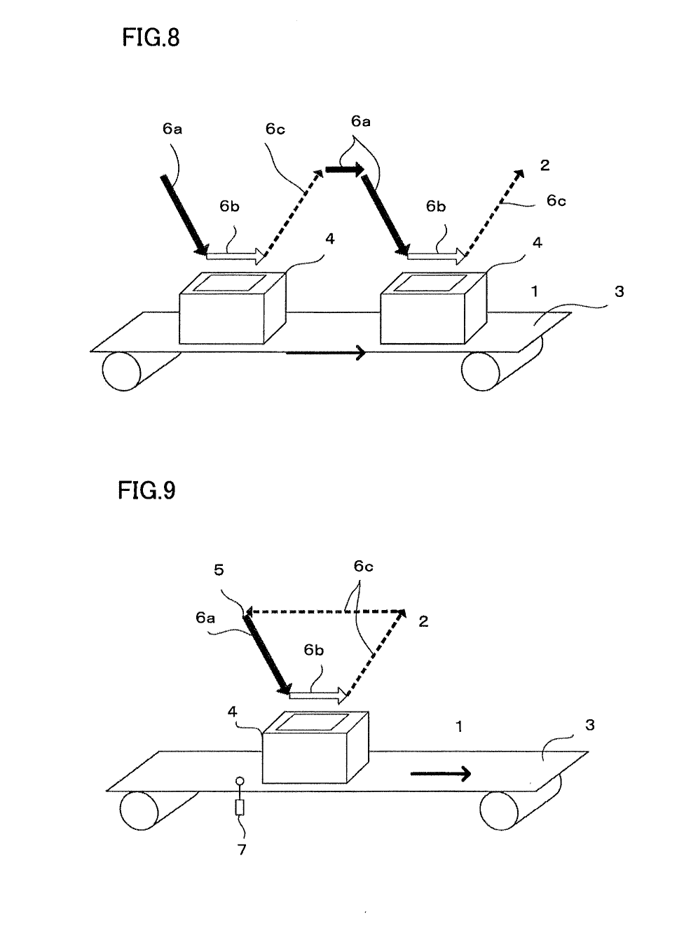

FIG. 8 is a diagram illustrating the system according to the second embodiment. The first embodiment performs the synchronous operation toward a position designated by the program. However, the interval for the synchronous operation does not always remain unchanged, due to the configuration of a machine and on the purpose. Referring to FIG. 8, the synchronization preparation operation 6a, the synchronous operation 6b, and the return operation 6c are performed when a workpiece 4 placed on the conveyor 3 is positioned to the left in FIG. 8. In the next cycle, however, the synchronization preparation operation 6a, the synchronous operation 6b, and the return operation 6c are performed when the workpiece 4 placed on the conveyor 3 is positioned to the right in FIG. 8. When such operating sequences are to be written as a same program, it is necessary to designate the movement amounts of the master axis 1 and slave axis 2 instead of their end point positions.

A machine capable of arbitrarily designating the position of the slave axis for machining may operate without using a command that designates an end point position. In such an instance, the movement of the machine can be written by designating a relative movement amount for the synchronization preparation operation of the slave axis 2. In this case, the end point position of an operation can be determined by adding a movement amount designated by the program to the position of the slave axis 2 that prevails at the beginning of the operation. Using the above-described determined end point positions makes it possible to perform the same synchronization preparation operation as the first embodiment.

### Third Embodiment

A third embodiment of the present invention is included in claim 3.

FIG. 9 is a diagram illustrating the system according to the third embodiment. If, for instance, the master axis 1 of the machine does not have absolute position information, machining starts upon receipt, for instance, of a signal input from a machining start switch 7. Therefore, coordinate values of the synchronization interval of the master axis 1 are not determined until immediately before the start of machining. As the master axis coordinate values cannot be written beforehand in the program, the movement amount is designated for the synchronous operation and synchronization preparation operation.

An end point position of an operation can be determined by adding a movement amount designated by the program to the position of the master axis 1 at the beginning of the operation. Using the above-described determined end point positions makes it possible to perform the same synchronization preparation operation as the first embodiment.

### Fourth Embodiment

A fourth embodiment of the present invention is included in claim 4.

In the fourth embodiment, the movement amount is designated for both the master axis and the slave axis. The synchronization control apparatus according to the fourth embodiment has both the features of the slave axis 2 according to the second embodiment and the features of the master axis 1 according to the third embodiment.

### Fifth Embodiment

A fifth embodiment of the present invention is included in claim 5.

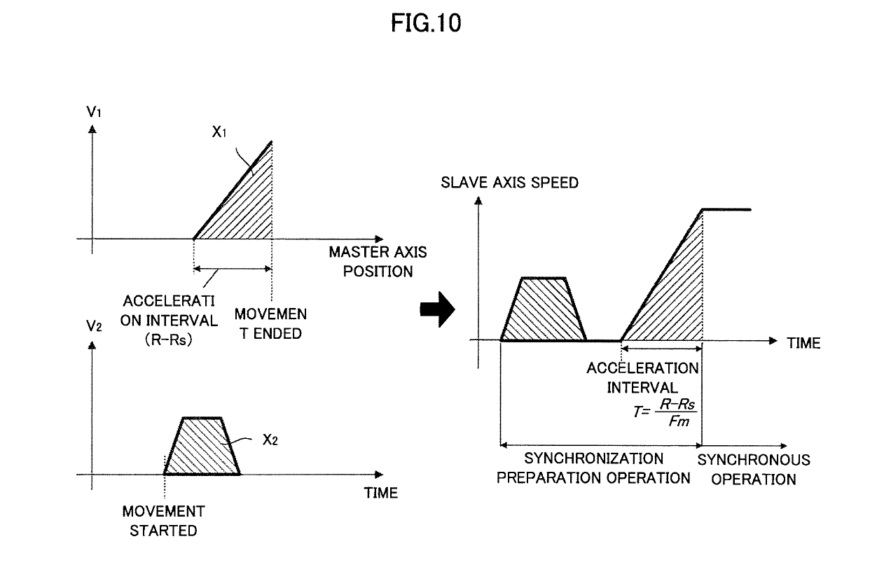

FIG. 10 is a diagram illustrating the fifth embodiment. In the first embodiment, if the movement pattern of the slave axis is not changed in a situation where the program is operated with changing the speed of the master axis during a synchronous operation, the acceleration changes. As such being the case, the operation of the slave axis is determined so as to achieve designated acceleration during an interval during which the slave axis is accelerated in accordance with the movement of the master axis. In this instance, the slave axis can be operated at the designated acceleration by calculating the movement amounts X₁ and X₂ in such a manner as to provide a movement amount required for the entire synchronization preparation operation.

The following is a description of a case where Aₛ is designated as the acceleration of the slave axis instead of designating the acceleration/deceleration time T of the slave axis in the first embodiment. In order to let the slave axis attain a speed Fₘ*Q, which is obtained by multiplying the speed of the master axis by the speed ratio Q, it is necessary to accelerate the slave axis for a period of time expressed by Equation 4.

$$t = \frac{{F}_{m} \times Q}{{A}_{s}} \qquad ( 4 )$$

In the above instance, the acceleration remains unchanged. Therefore, the slave axis begins to accelerate at a position that is forward of an end point by the amount expressed by Equation 5.

$$\frac{1}{2} {A}_{s} {t}^{2} = \frac{{( {F}_{m} \times Q )}^{2}}{2 {A}_{s}} \qquad ( 5 )$$

In other words, the amount of slave axis movement during the acceleration interval is expressed by Equation 6.

$${X}_{1} = \frac{{( {F}_{m} \times Q )}^{2}}{2 {A}_{s}} \qquad ( 6 )$$

The distance between a start point Rₛ and an end point R, which represents the amount of master axis movement during the acceleration interval, is expressed by Equation 7.

$$R - {R}_{s} = t \times {F}_{m} = \frac{{F}_{m}^{2} \times Q}{{A}_{s}} \qquad ( 7 )$$

Thus, the master axis position Rₛ at which master axis acceleration begins can be calculated from Equation 8.

$${R}_{s} = R - \frac{{F}_{m}^{2} \times Q}{{A}_{s}} \qquad ( 8 )$$

When the above method is used, the slave axis performs the synchronization preparation operation at the designated acceleration A. Therefore, the synchronous operation can be started without changing the acceleration even if the program is operated with the master axis speed changed.

### Sixth Embodiment

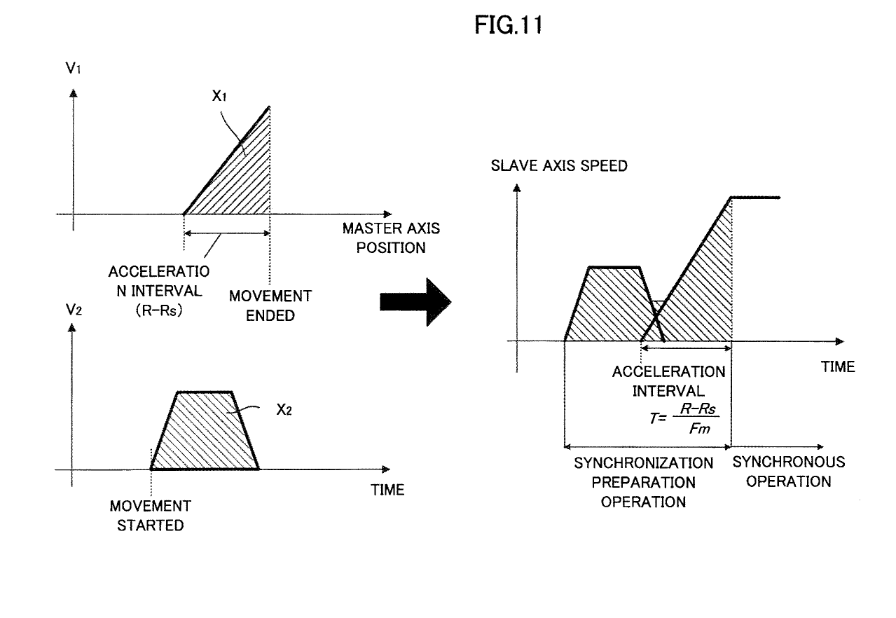

FIG. 11 is a diagram illustrating a sixth embodiment of the present invention. In the first embodiment, the slave axis is moved by the movement amount X₁ after being moved by the movement amount X₂ and stopped. Therefore, the slave axis needs to be completely moved by the movement amount X₂ before the master axis arrives at the position Rₛ. This increases the speed and acceleration of the slave axis for the movement amount X₂. As such being the case, the two movements are made simultaneously in parallel. This enables the slave axis to continuously move by the movement amount X₂ after it starts moving by the movement amount X₁ when the master axis arrives at the position Rₛ. As a result, the speed and acceleration can be kept low.

In the first embodiment, immediately after the start, a speed V₂ is calculated from the movement amount X₂ in order to move the slave axis. Subsequently, the position of the master axis is monitored in the first embodiment. In the sixth embodiment, however, the position of the master axis is monitored to be able to start an acceleration operation by the movement amount X₁ without waiting for the completion of movement by the movement amount X₂. The speed for the movement amount X₁ after the start is assumed to be V₁. Then the value V₁+V₂ is designated to the speed of the slave axis to let operations overlap.

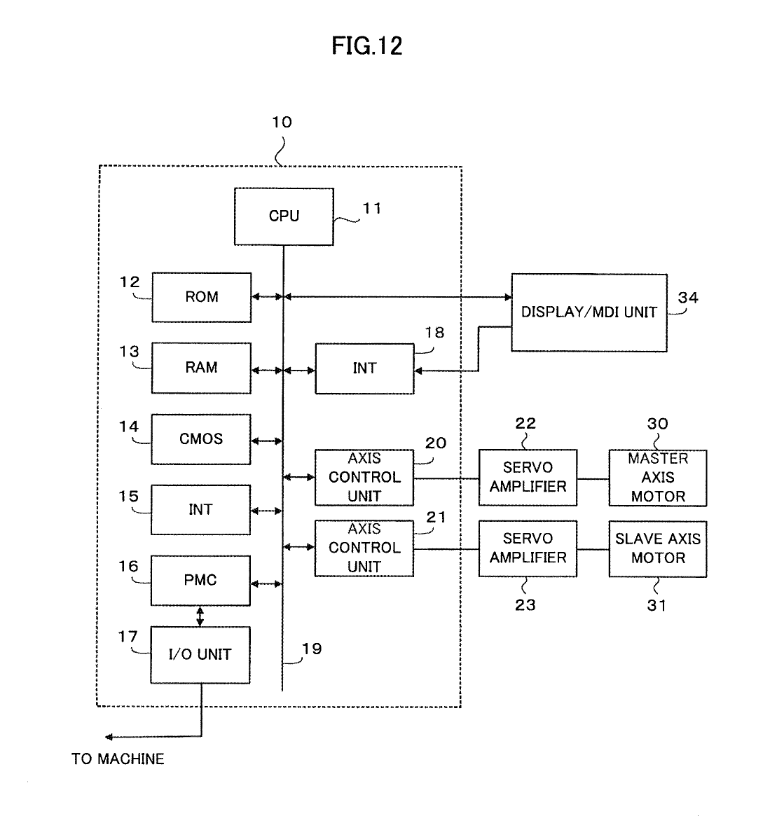

FIG. 12 is a diagram illustrating a numerical control apparatus, which is a synchronization control apparatus for controlling operations including the above-described preparation operation. A CPU 11 in the synchronization control apparatus 10 is a processor that provides overall control of the synchronization control apparatus 10. The CPU 11 reads a system program, which is stored in a ROM 12, through a bus 19, and controls the whole control apparatus in accordance with the system program. A RAM 13 stores temporary calculation data and display data as well as various data input by an operator through a display/MDI unit 34.

A CMOS 14 is backed up by a battery (not shown) and configured as a nonvolatile memory that retains its content even when the synchronization control apparatus 10 is turned off. The CMOS 14 stores, for example, an operating program read through an interface 15 and an operating program input through the display/MDI unit 34.

The interface 15 permits the synchronization control apparatus 10 to be connected to an external device such as an adapter. An operating program or the like is read from an external device. A programmable machine controller (PMC) 16 uses a sequence program incorporated in the synchronization control apparatus 10 in order to output a signal to an auxiliary device of the machine through an I/O unit 17 for control purposes.

The display/MDI unit 34 is a manual data input device having, for example, a display and a keyboard. An interface 18 receives commands and data from the keyboard of the display/MDI unit 34 and delivers them to the CPU 11.

An axis control units 20, 21 for each axis receives a commanded movement amount of each axis from the CPU 11 and outputs a command for each axis to a servo amplifier 22, 23. Upon receipt of the command, the servo amplifier 22, 23 drives a servo motor 30, 31 for the master axis or the slave axis. The servo motor 30, 31 for the master or slave axis incorporates a position/speed detector. A position/speed feedback signal from the position/speed detector is fed back to the axis control units 20, 21 to exercise position/speed feedback control. Position/speed feedback is omitted from FIG. 3.

In the embodiment depicted in FIG. 7, the synchronization control apparatus 10 provides synchronization control of two axes, namely, the master axis and the slave axis, by using the axis control units 20, 21 and servo amplifiers 22, 23, which control the servo motors 30, 31 for the master and slave axes. However, any other axis can be additionally controlled by connecting the axis control units, servo amplifier, and servo motor to the bus 19.

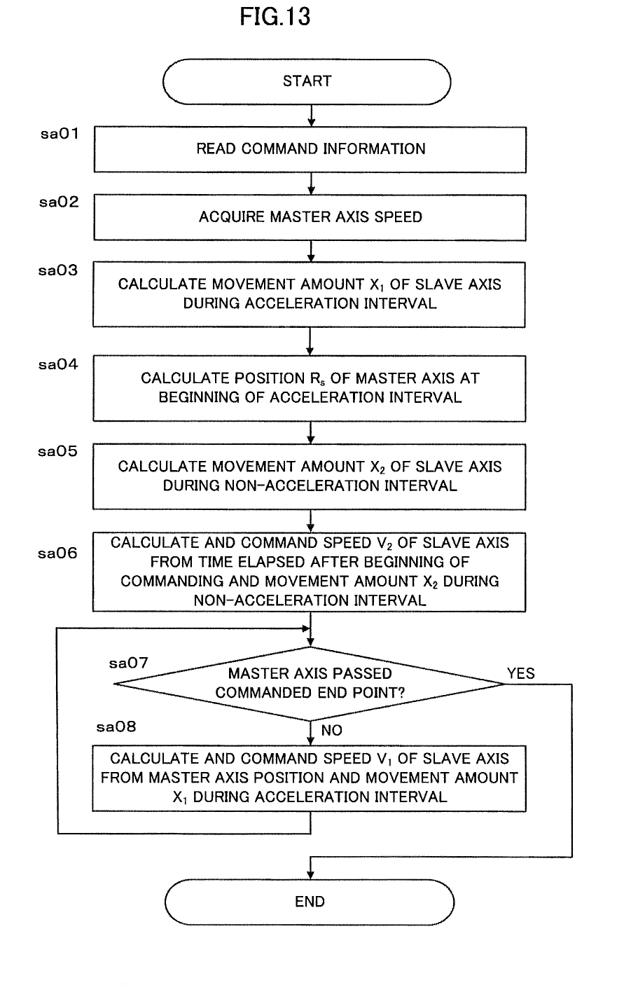

FIG. 13 is a flowchart illustrating a process according to the first embodiment. Individual steps of the process will now be described.

[Step sa01] Command information is read from a block of the program. This step corresponds to (1) of the first embodiment.

[Step sa02] The master axis speed is acquired.

[Step sa03] The movement amount X₁ of the slave axis during the acceleration interval is calculated. This step corresponds to (2) of the first embodiment.

[Step sa04] The position Rₛ of the master axis, which is a start condition for the acceleration interval, is calculated.

[Step sa05] The movement amount X₂ of the slave axis during a non-acceleration interval is calculated.

[Step sa06] The speed V₂ of the slave axis is calculated from time elapsed after the beginning of commanding and the movement amount X₂ during the non-acceleration interval. The calculated speed V₂ is then commanded. This step corresponds to (3) of the first embodiment.

[Step sa07] A check is performed to determine whether the master axis has passed a commanded end point. If the master axis has passed the commanded end point (YES), the process terminates. If the master axis has not passed the commanded end point (NO), processing proceeds to step sa08. Step sa07 corresponds to (4) of the first embodiment.

[Step sa08] The speed V₁ of the slave axis is calculated from the master axis position and the movement amount X₁ during the acceleration interval. The calculated speed V₁ is then commanded. Upon completion of step sa08, processing returns to step sa07.

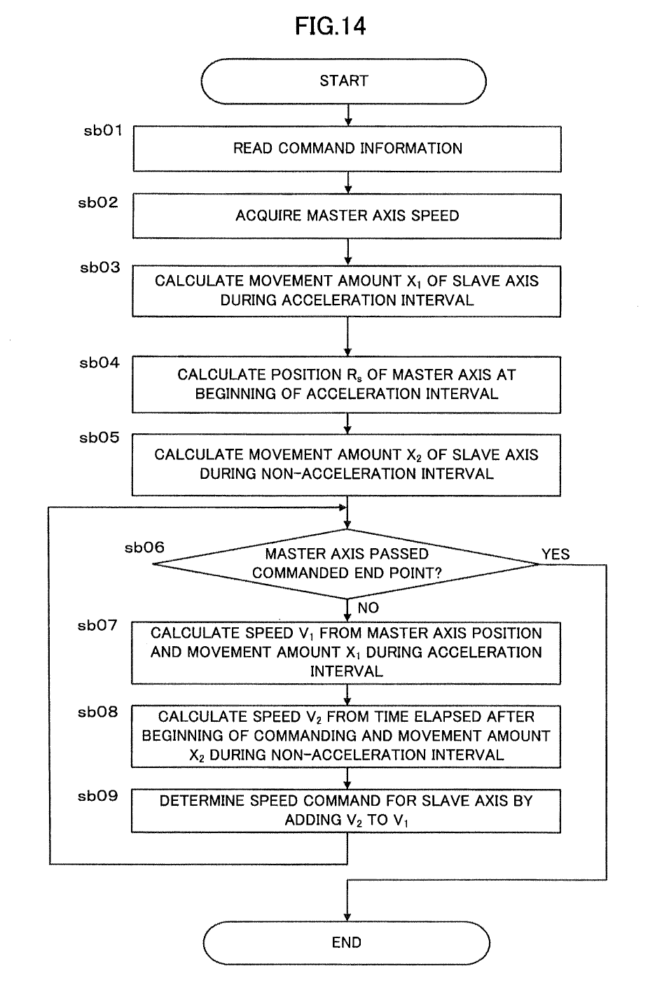

FIG. 14 is a flowchart illustrating the process according to the sixth embodiment. Individual steps of the process will now be described.

[Step sb01] Command information is read from a block of the program.

[Step sb02] The master axis speed is acquired.

[Step sb03] The movement amount X₁ of the slave axis during the acceleration interval is calculated.

[Step sb04] The position R₅ of the master axis, which is a start condition for the acceleration interval, is calculated.

[Step sb05] The movement amount X₂ of the slave axis during the non-acceleration interval is calculated.

[Step sb06] A check is performed to determine whether the master axis has passed a commanded end point. If the master axis has passed the commanded end point (YES), the process terminates. If the master axis has not passed the commanded end point (NO), processing proceeds to step sb07.

[Step sb07] The speed V₁ is calculated from the master axis position and the movement amount X₁ during the acceleration interval.

[Step sb08] The speed V₂ is calculated from time elapsed after the beginning of commanding and the movement amount X₂ during the non-acceleration interval.

[Step sb09] A speed command for the slave axis is determined by adding V₂ to V₁. Upon completion of step sb09, processing returns to step sb06.

1. A synchronization control apparatus for initiating a synchronous operation immediately after a slave axis moves to a designated position while a master axis moves to a designated position, the synchronization control apparatus comprising:
a designation unit configured to designate a position of the master axis, a position of the slave axis, and a speed ratio that prevails when the master axis and the slave axis finish the designated movement;
a movement amount calculation unit configured to calculate a movement amount required for the slave axis to move in accordance with the position of the master axis in such a manner that the slave axis moves to the designated position when the master axis arrives at the designated position, and that the speed ratio of the slave axis to the master axis is as designated by the designation unit; and
a movement unit configured to move the slave axis to the position that is forward of the designated position by the movement amount calculated by the movement amount calculation unit, and then move the slave axis to an end point in accordance with the position of the master axis.

2. A synchronization control apparatus that initiates a synchronous operation immediately after a slave axis moves a designated distance while a master axis moves to a designated position, the synchronization control apparatus comprising:
a designation unit configured to designate a position of the master axis, a movement amount of the slave axis, and a speed ratio that prevails when the master axis and the slave axis finish the designated movement;
a movement amount calculation unit configured to calculate a movement amount required for the slave axis to move in accordance with the position of the master axis in such a manner that the slave axis moves the designated distance when the master axis arrives at the designated position, and that the speed ratio of the slave axis to the master axis is as designated by the designation unit; and
a movement unit configured to move the slave axis by an amount that is calculated by subtracting the movement amount calculated by the movement amount calculation unit from the designated movement amount, and then move the slave axis to an end point in accordance with the position of the master axis.

3. A synchronization control apparatus for initiating a synchronous operation immediately after a slave axis moves to a designated position while a master axis moves a designated distance, the synchronization control apparatus comprising:
a designation unit configured to designate a movement amount of the master axis, a position of the slave axis, and a speed ratio that prevails when the master axis and the slave axis finish the designated movement;
a movement amount calculation unit configured to calculate a movement amount required for the slave axis to move in accordance with the position of the master axis in such a manner that the slave axis moves to the designated position when the master axis finishes moving the designated distance, and that the speed ratio of the slave axis to the master axis is as designated by the designation unit; and
a movement unit configured to move the slave axis to the position that is forward of the designated position by the movement amount calculated by the movement amount calculation unit, and then move the slave axis to an end point in accordance with the position of the master axis.

4. A synchronization control apparatus for initiating a synchronous operation immediately after a slave axis moves a designated distance while a master axis moves a designated distance, the synchronization control apparatus comprising:
a designation unit configured to designate a movement amount of the master axis, a movement amount of the slave axis, and a speed ratio that prevails when the master axis and the slave axis finish the designated movement;
a movement amount calculation unit configured to calculate a movement amount required for the slave axis to move in accordance with the position of the master axis in such a manner that the slave axis moves by the designated movement amount when the master axis finishes moving the designated distance, and that the speed ratio of the slave axis to the master axis is as designated by the designation unit; and
a movement unit configured to move the slave axis by an amount that is calculated by subtracting the movement amount calculated by the movement amount calculation unit from the designated movement amount, and then move the slave axis to an end point in accordance with the position of the master axis.

5. The synchronization control apparatus according to claim 1, further comprising:
a designation unit configured to designate an acceleration of the slave axis;
wherein the movement amount calculation unit is configured to calculate a movement amount in such a manner that an acceleration prevailing during movement agrees with the designated acceleration.

6. The synchronization control apparatus according to claim 1, wherein the movement unit is configured to move the slave axis at a speed that is calculated by adding an axis speed of the slave axis for movement to an acceleration start position to an axis speed for accelerating the slave axis in accordance with the master axis.

7. The synchronization control apparatus according to claim 5, wherein the movement unit is configured to move the slave axis at a speed that is calculated by adding an axis speed of the slave axis for movement to an acceleration start position to an axis speed for accelerating the slave axis in accordance with the master axis.

8. The synchronization control apparatus according to claim 2, further comprising:
a designation unit configured to designate an acceleration of the slave axis;
wherein the movement amount calculation unit is configured to calculate a movement amount in such a manner that an acceleration prevailing during movement agrees with the designated acceleration.

9. The synchronization control apparatus according to claim 3, further comprising:
a designation unit configured to designate an acceleration of the slave axis;
wherein the movement amount calculation unit is configured to calculate a movement amount in such a manner that an acceleration prevailing during movement agrees with the designated acceleration.

10. The synchronization control apparatus according to claim 4, further comprising:
a designation unit configured to designate an acceleration of the slave axis;
wherein the movement amount calculation unit is configured to calculate a movement amount in such a manner that an acceleration prevailing during movement agrees with the designated acceleration.

11. The synchronization control apparatus according to claim 2, wherein the movement unit is configured to move the slave axis at a speed that is calculated by adding an axis speed of the slave axis for movement to an acceleration start position to an axis speed for accelerating the slave axis in accordance with the master axis.

12. The synchronization control apparatus according to claim 3, wherein the movement unit is configured to move the slave axis at a speed that is calculated by adding an axis speed of the slave axis for movement to an acceleration start position to an axis speed for accelerating the slave axis in accordance with the master axis.

13. The synchronization control apparatus according to claim 4, wherein the movement unit is configured to move the slave axis at a speed that is calculated by adding an axis speed of the slave axis for movement to an acceleration start position to an axis speed for accelerating the slave axis in accordance with the master axis.

14. The synchronization control apparatus according to claim 8, wherein the movement unit is configured to move the slave axis at a speed that is calculated by adding an axis speed of the slave axis for movement to an acceleration start position to an axis speed for accelerating the slave axis in accordance with the master axis.

15. The synchronization control apparatus according to claim 9, wherein the movement unit is configured to move the slave axis at a speed that is calculated by adding an axis speed of the slave axis for movement to an acceleration start position to an axis speed for accelerating the slave axis in accordance with the master axis.

16. The synchronization control apparatus according to claim 10, wherein the movement unit is configured to move the slave axis at a speed that is calculated by adding an axis speed of the slave axis for movement to an acceleration start position to an axis speed for accelerating the slave axis in accordance with the master axis.
